(19) United States
(12) Patent Application Publication
(10) Pub. No.: US 2026/0276166 A1
(43) Pub. Date: Sep. 17, 2026

(54) LINEAR LIGHT-EMITTING DEVICE, LAMP ASSEMBLY, AND VEHICLE

(71) Applicant: VALEO VISION, Bobigny (FR)

(72) Inventors: Junlun DONG, Foshan (CN); Changqi WU, Foshan (CN); Wenqing CHEN, Foshan (CN); Yingeng CHENG, Foshan (CN); Jiehong LONG, Foshan (CN); Hongze LUO, Foshan (CN); Zhifeng LI, Foshan (CN)

(73) Assignee: VALEO VISION, Bobigny (FR)

(21) Appl. No.: 19/473,357

(22) PCT Filed: Apr. 5, 2024
(86) PCT No.: PCT/EP2024/059407

§ 371 Date: Oct. 7, 2025

(30) Foreign Application Priority Data
Apr. 7, 2023 (CN) 202320761117.6
Apr. 7, 2023 (CN) 202320778140.6
Jun. 30, 2023 (CN) 202310804803.1

(51) Int. Cl. F21S 43/237; F21S 43/20; F21S 43/242; F21S 43/31; F21S 43/37; F21S 45/47; F21W 103/20; F21W 103/35; F21W 103/55

(52) U.S. Cl. CPC F21S 43/237; F21S 43/242; F21S 43/2641; F21S 43/31; F21S 43/37; F21S 45/47; F21V 2200/10; F21W 2103/20; F21W 2103/35; F21W 2103/55

(57) ABSTRACT

The invention provides a linear light-emitting device, comprising a plurality of linear light-emitting elements, all of which are laterally light-emitting elements for jointly forming a lateral light exit region of the linear light-emitting device, wherein for at least a portion of the linear light-emitting device, each linear light-emitting element comprises: a core layer, which is rod-shaped and at least one end side of which is configured to receive and input light from a light source; a cladding layer covering the outer side of the core layer, wherein the refractive index of the cladding layer is lower than that of the core layer, and light from the core layer enters the cladding layer through refraction; and a reflective layer, formed on the outer side of the cladding layer and configured to reflect light from the cladding layer towards the lateral light exit region.

### TECHNICAL FIELD

Embodiments of the present invention generally relate to the field of lighting and/or signal indication, and more specifically, to a linear light-emitting device, a lamp assembly, and a Vehicle.

### BACKGROUND OF THE INVENTION

Linear light-emitting elements, such as optical fibers, are often used in Vehicles to provide specific lighting and/or signal indication functions, for example, being used in rear lights, daytime running lights, parking lights, indicator lights, etc., or as ambient lights in a driver's compartment to enhance the atmosphere.

In the prior art, a linear light-emitting element is usually composed of a core layer and a cladding layer covering the outer side of the core layer, wherein a scattering element is added to the covering layer, so that incident light from an end side of the linear light-emitting element to the inside of the core layer may exit from the entire outer peripheral surface of the linear light-emitting element, which means that a linear light-emitting element in the prior art emits light 360 degrees. This type of linear light-emitting element has the problem of low brightness.

In another aspect, in some cases, a single linear light-emitting element cannot provide the luminous intensity required in regulations or by host manufacturers for lighting and/or signal indication functions, for example, due to the limitation of the luminous power of coloured LEDs themselves or the presence of a component that causes light loss (for example, an external lens), etc.

### SUMMARY OF THE INVENTION

An objective of the present invention is to solve or overcome at least one of the above and other problems and shortcomings in the prior art.

According to one aspect of the present invention, a linear light-emitting device is provided, comprising a plurality of linear light-emitting elements, all of which are laterally light-emitting elements for jointly forming a lateral light exit region of the linear light-emitting device, wherein for at least a portion of the linear light-emitting device, each linear light-emitting element comprises:
a core layer, which is rod-shaped and at least one end side of which is configured to receive and input light from a light source;
a cladding layer covering the outer side of the core layer, wherein the refractive index of the cladding layer is lower than that of the core layer, and light from the core layer enters the cladding layer through refraction; and
a reflective layer, formed on the outer side of the cladding layer and configured to reflect light from the cladding layer towards the lateral light exit region.

In some embodiments, the plurality of linear light-emitting elements are formed integrally, or the linear light-emitting elements are each formed separately and stacked together in a direction transverse to the main light exit direction of the linear light-emitting device.

In some embodiments, at least one linear light-emitting element of the plurality of linear light-emitting elements has a reflective layer at least partially covering the outer side of the covering layer.

In some embodiments, the reflective layer is configured to cover at least half of the area of the outer peripheral surface of the covering layer.

In some embodiments, at least one linear light-emitting element of the plurality of linear light-emitting elements further comprises a transparent light exit layer at least partially covering the outer side of the covering layer, the transparent light exit layer being configured to transmit light from the cladding layer and the reflective layer.

In some embodiments, the transparent light exit layer is connected to the reflective layer on the outer peripheral surface of the cladding layer to jointly cover the outer peripheral surface of the covering layer.

In some embodiments, the lateral light exit region comprises at least a portion of the outer peripheral surface of the transparent light exit layer.

In some embodiments, at least one linear light-emitting element of the plurality of linear light-emitting elements further comprises:
a transparent light exit layer which envelops an outer peripheral surface of the covering layer, the transparent light exit layer being configured to transmit light from the covering layer; and
the reflective layer which is opaque and partially covers the outer peripheral surface of the transparent light exit layer, the reflective layer being configured to at least partially face the lateral light exit region to reflect light from the transparent light exit layer towards the lateral light exit region.

In some embodiments, the reflective layer is configured to cover more than half of the area of the outer peripheral surface of the transparent light exit layer.

In some embodiments, the lateral light exit region comprises at least a portion of the outer peripheral surface of the transparent light exit layer.

In some embodiments, the reflective layers of the plurality of linear light-emitting elements are formed integrally.

In some embodiments, the transparent light exit layers of the plurality of linear light-emitting elements are formed integrally.

In some embodiments, when the plurality of linear light-emitting elements are formed separately, each linear light-emitting element has a rectangular cross section and adjacent linear light-emitting elements tightly fit each other.

In some embodiments, at an end of the linear light-emitting device, the plurality of linear light-emitting elements do not have the reflective layer and/or the transparent light exit layer, so that the plurality of linear light-emitting elements are separable from each other at the end.

In some embodiments, the reflective layers of the plurality of linear light-emitting elements are formed integrally, and the reflective layer is formed with a partition between the cladding layers of adjacent linear light-emitting elements, wherein the side of the partition close to the lateral light exit region has a thickness of smaller than or equal to 1 mm.

In some embodiments, the linear light-emitting device comprises a laterally light-emitting flexible optical fiber.

According to another aspect of the present invention, an embodiment thereof further provides a lamp assembly comprising any one of the linear light-emitting devices as described above; a light source module, the light source module being configured to emit light towards at least one end of the linear light-emitting device; and a coupler, the coupler being configured to fix a relative position between the linear light-emitting device and the light source module.

In some embodiments, the lamp assembly further comprises a heat sink, the light source module being fixed to the heat sink.

According to yet another aspect of the present invention, an embodiment thereof further provides a Vehicle comprising a lamp assembly as described above.

Other objectives and advantages of the present invention will become obvious through the following detailed description of the invention with reference to the drawings, which can also aid comprehensive understanding of the invention.

### BRIEF DESCRIPTION OF THE DRAWINGS

These and/or other aspects, features and advantages of the present invention will become obvious and easy to understand through the following description of illustrative embodiments in conjunction with the accompanying drawings, wherein:

FIG. 1 is a schematic perspective view of a lamp assembly according to the present invention;

FIG. 2 is a schematic perspective view of one end side of the lamp assembly in FIG. 1;

FIG. 3 is a schematic cross-sectional view, taken along the line A-A, of the linear light-emitting device 1 according to a first embodiment of the present invention in FIG. 1;

FIG. 4 is a schematic cross-sectional view, taken along the line A-A, of the linear light-emitting device 1 according to a second embodiment of the present invention in FIG. 1;

FIG. 5 is a schematic cross-sectional view, taken along the line A-A, of the linear light-emitting device 1 according to a third embodiment of the present invention in FIG. 1; and

FIG. 6 is another schematic cross-sectional view, taken along the line A-A, of the linear light-emitting device 1 according to the third embodiment of the present invention in FIG. 1.

### DETAILED DESCRIPTION OF THE INVENTION

Embodiments of the present invention will be described in detail below in conjunction with the accompanying drawings. Herein, identical or similar components are indicated by identical or similar reference numerals. The following explanation of embodiments of the present invention with reference to the accompanying drawings is intended to explain the overall disclosed concept of the present invention, and should not be interpreted as a limitation of the present invention.

In addition, in the following detailed description, for ease of explanation, many specific details are expounded to provide a comprehensive understanding of the embodiments of the present invention. However, it is obvious that one or more embodiments may also be implemented without these specific details. In other scenarios, well-known structures and devices are shown in the form of illustrations to simplify the drawings.

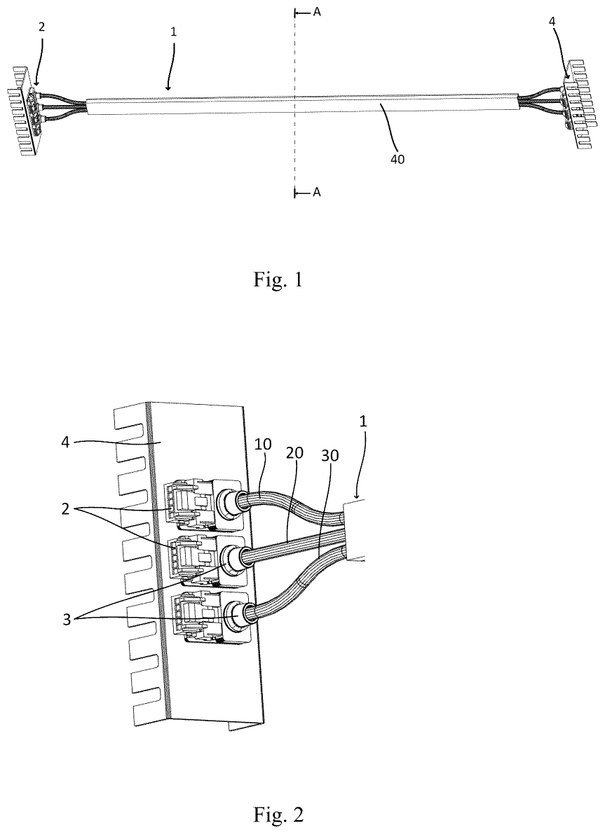

FIG. 1 is a schematic perspective view of a lamp assembly according to the present invention, and FIG. 2 is a schematic perspective view of one end side of the lamp assembly in FIG. 1. As shown in the drawings, a lamp assembly according to an embodiment of the present invention comprises a linear light-emitting device 1 and a light source module 2, wherein the linear light-emitting device 1 is of a laterally light-emitting type, the light source module 2 is configured to emit light rays towards an end side of the linear light-emitting device 1, these light rays enter the linear light-emitting device 1 and propagate longitudinally towards the other end side, while a portion of the light rays will exit from at least a portion of the outer peripheral surface of the linear light-emitting device 1, specifically, from the lateral light exit region 40 of the linear light-emitting device 1. As a non-restrictive example, the light source module 2 may comprise a printed circuit board and light-emitting elements, such as LEDs, installed on the printed circuit board. The light source module 2 may be arranged on one end side or two opposite end sides of the linear light-emitting device 1 as needed.

The lamp assembly further comprises a coupler 3 and a heat sink 4, wherein the coupler 3 is configured to fix a relative position between the linear light-emitting device 1 and the light source module 2, and the heat sink 4 is configured to fix the light source module 2, which may comprise a plurality of heat dissipation fins.

In embodiments of the present invention, a lamp assembly may be, for example, a rear light, a daytime running light, a parking light, an indicator light, or any other type of light

The linear light-emitting device 1 will be described in detail below with reference to different embodiments.

### 1. First Embodiment

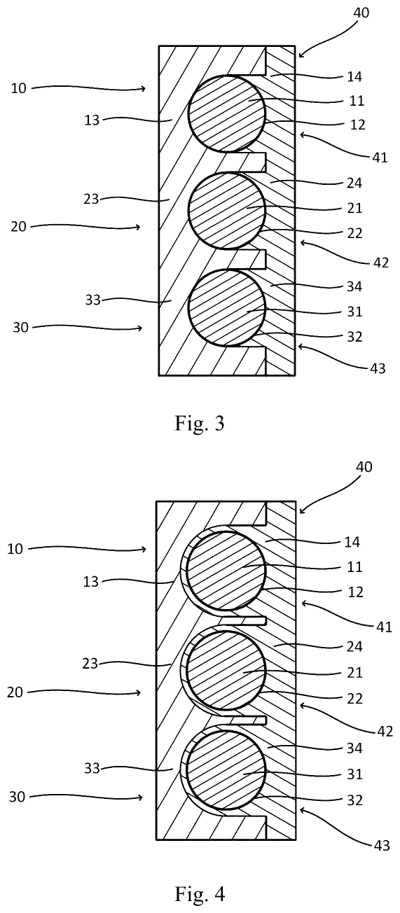

FIG. 3 is a schematic cross-sectional view, taken along the line A-A, of the linear light-emitting device 1 according to the first embodiment of the present invention in FIG. 1. As shown in FIG. 2 and FIG. 3, the linear light-emitting device 1 according to the first embodiment of the present invention comprises a plurality of linear light-emitting elements, for example, the first linear light-emitting element 10, the second linear light-emitting element 20, and the third linear light-emitting element 30 as shown in the drawings, wherein it is understandable that the number of linear light-emitting elements, rather than being limited thereto, may be determined according to specific regulatory requirements or requirements for the luminous intensity of the linear light-emitting device. Each linear light-emitting element is of the laterally light-emitting type, wherein, specifically, the first linear light-emitting element 10 has a first lateral light exit region 41, the second linear light-emitting element 20 has a second lateral light exit region 42, and the third linear light-emitting element 30 has a third lateral light exit region 43, these lateral light exit regions jointly constituting the lateral light exit region 40 of the linear light-emitting device 1.

For at least a portion, for example, the middle portion (namely the portion between the two ends), of the linear light-emitting device 1, as shown in FIG. 3, the first linear light-emitting element 10 comprises a first core layer 11, which is rod-shaped and made of transparent material, wherein light from a light source module 2 enters the interior of the first core layer 11 through an end side, the first core layer 11 being capable of propagating in a total reflection manner along the longitudinal direction of the first linear light-emitting element 10 towards the other end side, and, in addition, in this embodiment, the first core layer 11 has a circular cross-sectional shape, but the first core layer 11 may also have an elliptical, polygonal, or any other suitable cross-sectional shape; a first cladding layer 12 covering the outer side of the first core layer 11, the first cladding layer 12 being made of transparent material and having a refractive index lower than that of the first core layer 11, part of the light from the first core layer 11 being capable of entering the first cladding layer 12 through refraction, wherein, for example, the first cladding layer 12 may be made of scattering material, or light extraction elements (including, but not limited to, optical protrusions, optical indentations, optical textures, and sawteeth) are constructed on the first cladding layer 12, so that the condition for total reflection of part of the light in the first core layer 11 is disrupted and thus the light enters the first cladding layer 12.

It should be noted that in the present invention, “transparent material” refers to a material capable of transmitting light, which may be completely transparent or semi-transparent, and may also have other percentage transmission or haze values, without specific restrictions thereon.

The first linear light-emitting element 10 according to an embodiment of the present invention further comprises a first reflective layer 13, which contains an opaque material, at least partially covers the outer side of the first cladding layer 12, faces the first lateral light exit region 41, and is configured to reflect light from the first cladding layer 12 towards the first lateral light exit region 41.

In an embodiment of the present invention, by covering a portion of the outer side of the first cladding layer with a first reflective layer containing an opaque material, the first linear light-emitting element no longer emits light 360 degrees, but emits light only in the desired region (the first lateral light exit region), which allows a reduction of light leakage to improve the optical efficiency and increase the overall brightness of the first linear light-emitting element, so that even the lowest brightness can meet requirements.

Preferably, to allow more light to exit through the first lateral light exit region 41, the first reflective layer 13 is configured to cover more than half of the area of the outer peripheral surface of the first cladding layer 12.

Preferably, the first linear light-emitting element 10 according to an embodiment of the present invention may further comprise a first transparent light exit layer 14, made of transparent material and at least partially covering the outer side of the first cladding layer 12, which may be arranged opposite to the first reflective layer 13 and is configured to transmit light from the first cladding layer 12 and the first reflective layer 13, meaning that in this embodiment, the first lateral light exit region 41 comprises a portion of the outer peripheral surface of the first transparent light exit layer 14.

Preferably, the first transparent light exit layer 14 is circumferentially connected to the first reflective layer 13 on the outer peripheral surface of the first cladding layer 12 to jointly cover the outer peripheral surface of the first cladding layer 12, which means that the first reflective layer 13 covers a portion of the first cladding layer 12, while the first transparent light exit layer 14 covers the rest of the first cladding layer 12, the two being circumferentially connected to each other to avoid unexpected light leakage.

Preferably, the first transparent light exit layer 14 may comprise a scattering element for scattering light from a cladding layer or reflective layer to improve the uniformity of the lighting effect, for example, but not limited to, the first transparent light exit layer 14 being made of scattering material or scattering units, such as optical protrusions, optical depressions, and optical textures, being formed on its inner and/or outer peripheral surfaces.

In an embodiment of the present invention, the first cladding layer is covered with a first transparent light exit layer, the first transparent light exit layer being capable of protecting the first cladding layer to prevent the first cladding layer from being scratched, thereby avoiding unexpected bright spots caused by any scratches on the first covering layer, and, in addition, the first transparent light exit layer can also increase the friction resistance of the first linear light-emitting element.

Preferably, the various layers of the first linear light-emitting element 10 may be formed integrally, for example, by one or more of a co-extrusion process, a perfusion process, and an injection molding process, so as to reduce costs and simplify processes.

Further, as shown in FIG. 2 and FIG. 3, the second linear light-emitting element 20 may comprise a second core layer 21, a second cladding layer 22, a second reflective layer 23, and a second transparent light exit layer 24, wherein the third linear light-emitting element 30 may comprise a third core layer 31, a third cladding layer 32, a third reflective layer 33, and a third transparent light exit layer 34, and, for each layer of the second linear light-emitting element 20 and the third linear light-emitting element 30, reference may be made to the description of the corresponding layer of the first linear light-emitting element 10, which have the same features and thus will not be described in detail again herein.

In an embodiment of the present invention, a plurality of linear light-emitting elements are formed integrally. Specifically, the reflective layers of each linear light-emitting element are integrally formed, for example, but not limited to, being formed by a co-extrusion process, a perfusion process, an injection molding process, etc., which means that the first reflective layer 13, the second reflective layer 23, and the third reflective layer 33 are integrally formed, and/or the transparent light exit layers of each linear light-emitting element are integrally formed, for example, but not limited to, being formed by a co-extrusion process, a perfusion process, an injection molding process, etc., which means that the first transparent light exit layer 14, the second transparent light exit layer 24, and the third transparent light exit layer 34 are integrally formed. In other words, the same material may be used to form an integral reflective layer and an integral transparent light exit layer on the cladding layers of each linear light-emitting element.

It should be noted that in various embodiments of the present invention, “integral formation” refers to the simultaneous formation of different components through a specific process and constitution thereof into an integral part, or the direct formation of one component on another component on the basis of a specific process, wherein, in either case, different components are directly fixedly connected to each other through a specific process to form an integral part, without the need for being fixed together by any additional fixing means.

In the case where the reflective layers of each linear light-emitting element are formed integrally, to avoid any zones of opacity in lighting between adjacent linear light-emitting elements, adjacent linear light-emitting elements should be made as close to each other as possible. In one aspect, if a reflective layer covers an area on a cladding layer that is more than half of the area of the outer peripheral surface of the covering layer, then the reflective layer will form a partition between the cladding layers of adjacent linear light-emitting elements, wherein, for example, the partition 15 shown in FIG. 3 is a part of an integral reflective layer, which separates the cladding layer 12 of the first linear light-emitting element 10 from the cladding layer 22 of the second linear light-emitting element 20, in which case, preferably, the thickness of the partition 15 near the lateral light exit region 40 is made smaller than 1 mm to avoid any zones of opacity between adjacent linear light-emitting elements. In another aspect, if a reflective layer covers an area on a cladding layer that is smaller than half of the area of the outer peripheral surface of the covering layer, then, preferably, the cladding layers of adjacent linear light-emitting elements are made tangential to each other to avoid any zones of opacity between adjacent linear light-emitting elements.

In an embodiment of the present invention, by integrally forming each reflective layer and/or each transparent light exit layer, the production process is simplified, the need for any additional fixing means for the separate formation of each linear light-emitting element is eliminated, and the distance between linear light-emitting elements is reduced to avoid any possible zones of opacity.

In an embodiment of the present invention, by using a plurality of linear light-emitting elements formed integrally, the overall luminous intensity of the linear light-emitting device 1 may be increased, so that requirements of regulations or host manufacturers for luminous intensity are still met, for example, when the power of the light-emitting elements is low or there is light loss.

### 2. Second Embodiment

FIG. 4 is a schematic cross-sectional view, taken along the line A-A, of the linear light-emitting device 1 according to a second embodiment of the present invention in FIG. 1. As shown in FIG. 2 and FIG. 4, the linear light-emitting device 1 according to the second embodiment of the present invention comprises a plurality of linear light-emitting elements, such as the first linear light-emitting element 10, the second linear light-emitting element 20, and the third linear light-emitting element 30 as shown in the drawings, wherein it is understandable that the number of linear light-emitting elements, rather than being limited thereto, may be determined according to specific regulatory requirements or requirements for the luminous intensity of the linear light-emitting device. Each linear light-emitting element is of the laterally light-emitting type, wherein, specifically, the first linear light-emitting element 10 has a first lateral light exit region 41, the second linear light-emitting element 20 has a second lateral light exit region 42, and the third linear light-emitting element 30 has a third lateral light exit region 43, these lateral light exit regions jointly constituting the lateral light exit region 40 of the linear light-emitting device 1.

For at least a portion, for example, the middle portion (namely the portion between the two ends), of the linear light-emitting device 1, as shown in FIG. 3, the first linear light-emitting element 10 also comprises a first core layer 11, a first cladding layer 12, a first reflective layer 13, and a first transparent light exit layer 14, as in the first embodiment, wherein the first core layer 11 and the first cladding layer 12 are the same as those in the first embodiment and thus will not be described in detail again herein. The first transparent light exit layer 14 covers the outer peripheral surface of the first cladding layer 12, that is, completely covering the outer peripheral surface of the first cladding layer 12, the first transparent light exit layer 14 is formed of transparent material and configured to transmit light from the first cladding layer 12, and the lateral light exit region 41 of the first linear light-emitting element 10 comprises at least a portion of the outer peripheral surface of the first transparent light exit layer 14. The first reflective layer 13 at least partially covers the outer peripheral surface of the first transparent light exit layer 14, thereby being isolated from the first cladding layer 12, that is, not in contact with the first cladding layer 12, and the first reflective layer 13 contains an opaque material and is configured to at least partially face the first lateral light exit region 41 to reflect light from the first transparent light exit layer 14 towards the first lateral light exit region 41, wherein the reflected light will again pass through the first transparent light exit layer 14, the first cladding layer 12, and the first core layer 11 to reach the first lateral light exit region 41.

In an embodiment of the present invention, by covering the outer side of the first cladding layer with a first reflective layer containing an opaque material, the first linear light-emitting element no longer emits light 360 degrees, but emits light only in the desired region (the lateral light exit region), which allows a reduction of light leakage to improve the optical efficiency and increase the overall brightness of the first linear light-emitting element, so that even the lowest brightness can meet requirements.

In an embodiment of the present invention, the first cladding layer is covered with a first transparent light exit layer, the first transparent light exit layer being capable of protecting the first cladding layer to prevent the first cladding layer from being scratched, thereby avoiding unexpected bright spots caused by any scratches on the first covering layer, and, in addition, the first transparent light exit layer can also increase the friction resistance of the first linear light-emitting element.

In an embodiment of the present invention, if the first reflective layer covers a portion of the outer peripheral surface of the first covering layer, and the material of the first cladding layer has a poor bond to the material of the first reflective layer, for example, but not limited to, if the first cladding layer is formed of a fluorinated material, an air gap will appear between the first cladding layer and the first reflective layer, and since the first cladding layer is transparent but the first reflective layer is opaque, this air gap will be easily noticeable, seriously affecting the appearance. Therefore, in an embodiment of the present invention, the first transparent light exit layer covers the first covering layer, so that even if there is an air gap, since both layers are transparent, the air gap is unnoticeable.

Preferably, to allow more light to exit through the first lateral light exit region 41, the first reflective layer 13 is configured to cover more than half of the area of the outer peripheral surface of the first transparent light exit layer 14.

Preferably, the first transparent light exit layer 14 may comprise a scattering element for scattering light from the first cladding layer or first reflective layer to improve the uniformity of the lighting effect, for example, but not limited to, the first transparent light exit layer 14 being made of scattering material or scattering units, such as optical protrusions, optical depressions, and optical textures, being formed on its inner and/or outer peripheral surfaces.

Preferably, the various layers of the first linear light-emitting element 10 is formed integrally, for example, by one or more of a co-extrusion process, an injection molding process, and a perfusion process, so as to reduce costs and simplify processes.

Further, as shown in FIG. 2 and FIG. 4, the second linear light-emitting element 20 may comprise a second core layer 21, a second cladding layer 22, a second reflective layer 23, and a second transparent light exit layer 24, wherein the third linear light-emitting element 30 may comprise a third core layer 31, a third cladding layer 32, a third reflective layer 33, and a third transparent light exit layer 34, and, for each layer of the second linear light-emitting element 20 and the third linear light-emitting element 30, reference may be made to the description of the corresponding layer of the first linear light-emitting element 10, which have the same features and thus will not be described in detail again herein.

As in the first embodiment, a plurality of linear light-emitting elements are formed integrally. Specifically, the reflective layers of each linear light-emitting element are integrally formed, for example, but not limited to, being formed by a co-extrusion process, a perfusion process, an injection molding process, etc., which means that the first reflective layer 13, the second reflective layer 23, and the third reflective layer 33 are integrally formed, and/or the transparent light exit layers of each linear light-emitting element are integrally formed, for example, but not limited to, being formed by a co-extrusion process, a perfusion process, an injection molding process, etc., which means that the first transparent light exit layer 14, the second transparent light exit layer 24, and the third transparent light exit layer 34 are integrally formed. In other words, the same material may be used to form an integral transparent light exit layer on the cladding layers of each linear light-emitting element, and/or form an integral reflective layer on the transparent light exit layers of each linear light-emitting element.

In the case where the reflective layers of each linear light-emitting element are formed integrally, to avoid any zones of opacity in lighting between adjacent linear light-emitting elements, adjacent linear light-emitting elements should be made as close to each other as possible. In one aspect, if a reflective layer covers an area on a transparent light exit layer that is more than half of the area of the outer peripheral surface of the transparent light exit layer, then the reflective layer will form a partition between the cladding layers and transparent light exit layers of adjacent linear light-emitting elements, wherein, for example, the partition 15 shown in FIG. 3 is a part of an integral reflective layer, which separates the cladding layer 12 and transparent light exit layer 14 of the first linear light-emitting element 10, and the cladding layer 22 and transparent light exit layer 24 of the second linear light-emitting element 20, in which case, preferably, the thickness of the partition 15 near the lateral light exit region 40 is made smaller than 1 mm to avoid any zones of opacity between adjacent linear light-emitting elements. In another aspect, if a reflective layer covers an area on a transparent light exit layer that is smaller than half of the area of the outer peripheral surface of the transparent light exit layer, then, preferably, the transparent light exit layers of adjacent linear light-emitting elements are made tangential to each other to avoid any zones of opacity between adjacent linear light-emitting elements.

In an embodiment of the present invention, by integrally forming each reflective layer and/or each transparent light exit layer, the production process is simplified, the need for any additional fixing means for the separate formation of each linear light-emitting element is eliminated, and the distance between linear light-emitting elements is reduced to avoid any possible zones of opacity.

In an embodiment of the present invention, by using a plurality of linear light-emitting elements formed integrally, the overall luminous intensity of the linear light-emitting device 1 may be increased, so that requirements of regulations or host manufacturers for luminous intensity are still met, for example, when the power of the light-emitting elements is low or there is light loss.

It should be noted that although in the above two embodiments, each linear light-emitting element has an identical structure, it is understandable that in each embodiment, each linear light-emitting element may also have a different structure, wherein, for example, in the first embodiment, one or more linear light-emitting elements may have the structure in the second embodiment, and in the second embodiment, one or more linear light-emitting elements may have the structure in the first embodiment.

### 3. Third Embodiment

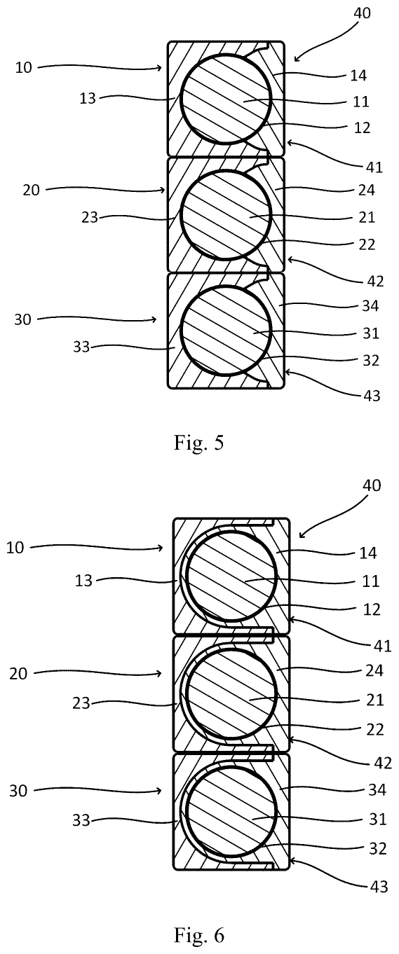

FIG. 5 is a schematic cross-sectional view, taken along the line A-A, of the linear light-emitting device 1 according to a third embodiment of the present invention in FIG. 1, and FIG. 6 is an another schematic cross-sectional view, taken along the line A-A, of the linear light-emitting device 1 according to the third embodiment of the present invention in FIG. 1. In one example, as shown in FIG. 5, the linear light-emitting device 1 according to the third embodiment of the present invention comprises a plurality of linear light-emitting elements, for example, the first linear light-emitting element 10, the second linear light-emitting element 20, and the third linear light-emitting element 30 as shown in the drawing, wherein the layer structure of each linear light-emitting element is identical to that of a linear light-emitting element in the first embodiment, and only its differences from the first embodiment will be described below. In another example, as shown in FIG. 6, the linear light-emitting device 1 according to the third embodiment of the present invention comprises a plurality of linear light-emitting elements, for example, the first linear light-emitting element 10, the second linear light-emitting element 20, and the third linear light-emitting element 30 as shown in the drawing, wherein the layer structure of each linear light-emitting element is identical to that of a linear light-emitting element in the second embodiment, and only its differences from the second embodiment will be described below.

In this embodiment, linear light-emitting elements are each formed separately and stacked together in a direction transverse to the main light exit direction of the linear light-emitting device. The main light exit direction of the linear light-emitting device 1 is consistent with the average propagation direction of the light from the lateral light exit regions of each linear light-emitting element, which may specifically be the horizontal direction indicated in FIG. 5 and FIG. 6, for example. In addition, “separate formation” refers to the manufacturing of different components independent of one another, which may be connected to each other or fixed together by additional fixing means. In other words, in this embodiment, linear light-emitting elements are each independently manufactured (a plurality of layers of each linear light-emitting element are preferably formed integrally) and then stacked together in a direction transverse to the main light exit direction of the linear light-emitting device.

Preferably, each linear light-emitting element has a rectangular cross section, and adjacent linear light-emitting elements tightly fit each other, thereby minimizing the number of zones of opacity when the appearance is illuminated. Tight fitting mentioned herein refers to the direct and tight fitting of adjacent linear light-emitting elements to each other without any mediums, for example, an adhesive, therebetween, in one case, and the tight fitting of adjacent linear light-emitting elements to each other through a medium, for example, an adhesive, in another case.

In the third embodiment of the present invention, by using a plurality of linear light-emitting elements formed separately but stacked together, the overall luminous intensity of the linear light-emitting device 1 may be increased, so that requirements of regulations or host manufacturers for luminous intensity are still met, for example, when the power of the light-emitting elements is low or there is light loss.

Further, for any of the above embodiments, at an end of the linear light-emitting device 1, as shown in FIG. 2, the first linear light-emitting element 10, the second linear light-emitting element 20, and the third linear light-emitting element 30 do not have a reflective layer and/or a transparent light exit layer, so that they are separable from each other at the end to cooperate with the coupler 3 and the light source module 2.

Further, among embodiments of the present invention, as a non-restrictive embodiment, the linear light-emitting device 1 may comprise a laterally light-emitting flexible optical fiber that is bendable as needed, but the present invention, rather than being limited thereto, may also be any other suitable type of light-emitting element.

An embodiment of the present invention further provides a Vehicle comprising a lamp assembly as described in any of the above embodiments.

Although the present invention has been explained in conjunction with the drawings, the embodiments disclosed in the drawings are intended to provide an exemplary illustration of preferred embodiments of the present invention, and must not be interpreted as a limitation of the present invention. The dimensional proportions in the drawings are merely schematic, and must not be interpreted as a limitation of the present invention.

Although some embodiments of the overall concept of the present invention have been shown and explained, those skilled in the art will understand that changes may be made to these embodiments without departing from the principles and spirit of the overall disclosed concept. The scope of the present invention is defined by the claims and their equivalents.

What is claimed is:

1. A linear light-emitting device, comprising a plurality of linear light-emitting elements, each of the plurality of linear light-emitting elements being a laterally light-emitting element for jointly forming a lateral light exit region of the linear light-emitting device, wherein for at least a portion of the linear light-emitting device, each linear light-emitting element includes:
a core layer, which is rod-shaped, wherein at least one end side of the core layer is configured to receive and input light from a light source;
a cladding layer covering the outer side of the core layer, wherein the refractive index of the cladding layer is lower than that of the core layer, and light from the core layer enters the cladding layer through refraction; and
a reflective layer formed on the outer side of the cladding layer, the reflective layer being configured to reflect light from the cladding layer towards the lateral light exit region.

2. The linear light-emitting device according to claim 1, wherein the plurality of linear light-emitting elements are formed integrally, or in that the linear light-emitting elements are each formed separately and stacked together in a direction transverse to the main light exit direction of the linear light-emitting device.

3. The linear light-emitting device according to claim 2, wherein at least one linear light-emitting element of the plurality of linear light-emitting elements has a reflective layer at least partially covering the outer side of the cladding layer.

4. The linear light-emitting device according to claim 3, wherein the reflective layer is configured to cover more than half of the area of the outer peripheral surface of the cladding layer.

5. The linear light-emitting device according to claim 3, wherein at least one linear light-emitting element of the plurality of linear light-emitting elements includes:
a transparent light exit layer at least partially covering the outer side of the cladding layer, the transparent light exit layer being configured to transmit light from the cladding layer and the reflective layer.

6. The linear light-emitting device according to claim 5, wherein the transparent light exit layer is connected to the reflective layer on the outer peripheral surface of the cladding layer to jointly cover the outer peripheral surface of the cladding layer.

7. The linear light-emitting device according to claim 5, wherein the lateral light exit region includes at least a portion of the outer peripheral surface of the transparent light exit layer.

8. The linear light-emitting device according to claim 2, wherein at least one linear light-emitting element of the plurality of linear light-emitting elements includes:
a transparent light exit layer covering the outer peripheral surface of the cladding layer, the transparent light exit layer being configured to transmit light from the cladding layer; and
the reflective layer which is opaque and partially covers the outer peripheral surface of the transparent light exit layer, the reflective layer being configured to at least partially face the lateral light exit region to reflect light from the transparent light exit layer towards the lateral light exit region.

9. The linear light-emitting device according to claim 8, wherein the reflective layer is configured to cover more than half of the area of the outer peripheral surface of the transparent light exit layer.

10. The linear light-emitting device according to claim 8, wherein the lateral light exit region comprises at least a portion of the outer peripheral surface of the transparent light exit layer.

11. The linear light-emitting device according to claim 2, wherein the reflective layers of the plurality of linear light-emitting elements are formed integrally.

12. The linear light-emitting device according to claim 5, wherein the transparent light exit layers of the plurality of linear light-emitting elements are formed integrally.

13. The linear light-emitting device according to claim 2, wherein, when the plurality of linear light-emitting elements are each formed separately, each linear light-emitting element has a rectangular cross section and adjacent linear light-emitting elements tightly fit each other.

14. The linear light-emitting device according to claim 5, wherein at an end of the linear light-emitting device, the plurality of linear light-emitting elements do not have the reflective layer and/or the transparent light exit layer, so that the plurality of linear light-emitting elements are separable from each other at the end.

15. The linear light-emitting device according to claim 4, wherein the reflective layers of the plurality of linear light-emitting elements are formed integrally, and in that the reflective layer is formed with a partition between the cladding layers of adjacent linear light-emitting elements, wherein the side of the partition close to the lateral light exit region has a thickness of smaller than or equal to 1 mm.

16. The linear light-emitting device according to claim 1, wherein the linear light-emitting device includes a laterally light-emitting flexible optical fiber.

17. A lamp assembly, comprising:
a linear light-emitting device, with the linear light-emitting device includes a plurality of linear light-emitting elements, each of the plurality of linear light-emitting elements being a laterally light-emitting element for jointly forming a lateral light exit region of the linear light-emitting device, wherein for at least a portion of the linear light-emitting device, each linear light-emitting element includes a core layer, which is rod-shaped, wherein at least one end side of the core layer is configured to receive and input light from a light source, a cladding layer covering the outer side of the core layer, wherein the refractive index of the cladding layer is lower than that of the core layer, and light from the core layer enters the cladding layer through refraction, and a reflective layer formed on the outer side of the cladding layer, the reflective layer being configured to reflect light from the cladding layer towards the lateral light exit region;
a light source module, the light source module being configured to emit light towards at least one end of the linear light-emitting device; and
a coupler, the coupler being configured to fix a relative position between the linear light-emitting device and the light source module.

18. The lamp assembly according to claim 17, further comprising a heat sink, with the light source module being fixed to the heat sink.

19. (canceled)
